(19) United States
(12) Patent Application Publication
(10) Pub. No.: US 2026/0250519 A1
(43) Pub. Date: Aug. 27, 2026

(54) Copper Containing Compounds and Compositions for Antimicrobial Paint and Coating

(71) Applicant: ARXADA, LLC, Morristown, NJ (US)

(72) Inventors: Milady Brutofsky, Cumming, GA (US); Kevin Janak, Blauvelt, NY (US); Lehong Jin, Huntersville, NC (US); Chun Liu, Morristown, NJ (US); Kathryn Neely, Alpharetta, GA (US)

(21) Appl. No.: 18/879,360

(22) PCT Filed: Jun. 30, 2023
(86) PCT No.: PCT/US2023/026712

§ 371 Date: Dec. 27, 2024

Related U.S. Application Data
(60) Provisional application No. 63/357,671, filed on Jul. 1, 2022.

(51) Int. Cl. C09D 5/02; C09D 5/14; C09D 7/41; C09D 7/61; C09D 7/65; C09D 107/02

(52) U.S. Cl. CPC C09D 5/025; C09D 5/022; C09D 5/028; C09D 5/14; C09D 7/41; C09D 7/61; C09D 7/65; C09D 107/02

(57) ABSTRACT

The present disclosure is generally directed to a polymer emulsion composition, the composition. The polymer emulsion composition includes a latex binder. The polymer emulsion composition further includes an insoluble cupric compound. The polymer emulsion composition further includes a complementary colored pigment. The insoluble cupric compound is present in the polymer emulsion composition in an amount less than about 4000 ppm Cu.

### RELATED APPLICATIONS

The present application is based on and claims priority to U.S. Provisional Patent Application Ser. No. 63/357,671 filed on Jul. 1, 2022, which is incorporated herein by reference.

### BACKGROUND

Paints and coatings are frequently used to protect a surface against corrosion, oxidation, or other types of deterioration. At every stage of their service lives, paints and coatings are susceptible to contamination and degradation by a variety of microorganisms, including virus, bacteria, fungi, and algae. Further, the presence of water and nutrients makes these paints, such as latex paints, susceptible to microbial attack-both in the wet state and as dry film. Microbial growth on the surface of latex paints may cause stains and deterioration, resulting in reduced durability of the paint and poor aesthetic quality of the surface. Thus, biocides or antimicrobials may be incorporated into paint formulations to reduce or inhibit the growth of microorganisms within the latex paint and preserve the aesthetic quality of the surface.

It is desirable to employ hygienic paints and coatings with a broad spectrum of antimicrobial efficacies against viruses and bacteria with minimal impact on the color of dry film. Due to government regulations and production costs, it may be desirable to employ a combination of antimicrobials with reduced amounts of each antimicrobial, while still achieving a high antimicrobial efficacy.

Accordingly, there is a need for employing improved antimicrobial compositions in polymer emulsions.

### SUMMARY

In general, the present disclosure is directed to a polymer emulsion composition and an antimicrobial composition. The compositions disclosed herein may be incorporated in an in-can, wet-state preservative additive for a latex emulsion composition, such as a latex paint composition. Notably, the compositions of the present disclosure advantageously exhibit antimicrobial properties. Specifically, employing insoluble cupric compounds, in combination with a complementary colored pigment, in a polymer emulsion composition as described by the present disclosure has been found to result in a polymer emulsion composition exhibiting a broad range of antimicrobial properties while surprisingly avoiding undesirable color impacts. Furthermore, the components of the compositions disclosed herein may also exhibit a beneficial potentiation in order to advantageously utilize a reduced amount of compositions while still achieving a desired degree of antimicrobial efficacy.

In one embodiment, a polymer emulsion composition includes an insoluble cupric compound. The polymer emulsion composition further includes a complementary colored pigment. Notably, the insoluble cupric compound is present in the polymer emulsion composition in an amount of less than about 4,000 ppm Cu.

In one example aspect, the insoluble cupric compound may include at least one of basic copper (II) carbonate, copper (II) hydroxide, copper 8-quinolinolate, copper (II) pyrithione, copper acetylacetonate, copper (II) oxide, or a combination thereof.

In another example aspect, the complementary colored pigment may include a red or white pigment.

In another example aspect, the complementary colored pigment may include at least one of iron (III) oxide, diketopyrrolopyrrole, dibromanthranthrone, zinc oxide, or a combination thereof.

In another example aspect, the complementary colored pigment may be present in a total amount of less than or equal to about 5000 ppm.

In another example aspect, the insoluble cupric compound may be present in the polymer composition in a total amount of from about 100 ppm to about 1800 ppm.

In another example aspect, the insoluble cupric compound can be micronized insoluble cupric compound particles and is 50% or more of the micronized insoluble cupric compound particles have a median particle size of less than about 1 micron.

In another example aspect, the polymer emulsion composition may further include a co-biocide, such as at least one derivative of quaternary ammonium, isothiazolinone, pyrithione, triazine, haloalkylnyl, hydantoin, urea, or a combination thereof.

In another example aspect, the co-biocide may include at least one of dimethyl benzyl ammonium chloride, N,N-didecyl-N,N-dimethyl ammonium chloride, N,N-didecyl-N,N-dimethyl ammonium carbonate/bicarbonate, zinc pyrithione, sodium pyrithione, or a combination thereof.

In another example aspect, the co-biocide can be present in a total amount of from about 50 ppm to about 5500 ppm.

In another example aspect, may further include an adjuvant.

In another example aspect, the adjuvant may include at least one of 2-dicyandiamide, zinc trifluoroethylacetoacetate, or a combination thereof.

In another example aspect, a latex paint composition may include the polymer emulsion composition disclosed herein.

Each of the example aspects recited above may be combined with one or more of the other example aspects recited above in certain embodiments. For instance, all of the example aspects recited above may be combined with one another in some embodiments. As another example, any combination of two, three, four, five, or more of the twenty example aspects recited above may be combined in other embodiments. Thus, the example aspects recited above may be utilized in combination with one another in some example embodiments. Alternatively, the example aspects recited above may be individually implemented in other example embodiments. Accordingly, it will be understood that various example embodiments may be realized utilizing the example aspects recited above.

In another example embodiment, an antimicrobial composition includes an insoluble cupric compound including basic copper carbonate. The antimicrobial composition further includes a complementary colored pigment. Notably, the insoluble cupric compound is present in the antimicrobial composition in an amount of less than about 4,000 ppm.

These and other features and aspects, embodiments and advantages of the present invention will become better understood with reference to the following description and appended claims.

### DETAILED DESCRIPTION

Reference will now be made in detail to example embodiments of the disclosure. It is to be understood by one of ordinary skill in the art that the present disclosure is a description of exemplary embodiments only and is not intended as limiting the broader aspects of the present disclosure.

The present disclosure is generally directed to a polymer emulsion composition and an antimicrobial composition. The polymer emulsion composition may include an insoluble cupric compound. Further, the polymer emulsion composition may include a complementary colored pigment. Notably, the insoluble cupric compound is present in the polymer composition in an amount less than about 4000 ppm Cu.

Compositions disclosed herein may advantageously exhibit antiviral and antimicrobial properties. Specifically, the polymer emulsion composition and antimicrobial composition have a broad spectrum of antimicrobial activity against various microorganisms. Additionally, the insoluble cupric compound in combination with a complementary colored pigment may advantageously limit or inhibit growth of microorganisms without staining the polymer emulsion composition. The insoluble cupric compounds as described herein are conventionally understood to impart color, such as a green hue, to paints and coatings. However, the polymer emulsion composition and the biocidal of the present disclosure may advantageously exhibit antimicrobial properties while surprisingly avoiding the color impact conventional expected with the insoluble cupric compounds.

In addition, the polymer emulsion composition and antimicrobial composition disclosed herein may, optionally, include various other components, such as a co-biocide, an adjuvant compound, or a combination thereof. Of particular advantage, the polymer emulsion composition and the antimicrobial composition disclosed herein may exhibit a potentiation interaction and a relatively high degree antimicrobial efficacy against a wide variety of microorganisms.

“Potentiation interaction” as used herein refers the insoluble cupric compound in combination with a complementary colored pigment have a total effect that is greater than the biocidal or antimicrobial properties of the antimicrobial acting alone. For instance, the insoluble cupric compound and the complementary colored pigment disclosed herein, optionally in combination with one or both of the co-biocide and the adjuvant compound, operate together so as to have greater antimicrobial activity in the presence of each against a certain microorganism than in comparison to the antimicrobial activity of the insoluble cupric compound alone. Due to this potentiation effect, the amount of the insoluble cupric compound and complementary colored pigment present in the composition can be reduced while still producing the desired efficacy.

The combination of co-biocides and additives combined together in accordance with the present disclosure includes at least an insoluble cupric compound and a complementary colored pigment. In some examples, one or more co-biocides may be present to further enhance the effects. Consequently, the amount of the insoluble cupric compound present in the composition can be reduced or minimized. For instance, the polymer emulsion composition and antimicrobial composition may include a total amount of the insoluble cupric compound and the complementary colored pigment together that is less than if only one were present, while still having the same or better efficacy against one or more microorganisms.

In accordance with example aspects of the present disclosure, the insoluble cupric compound generally includes a copper compound, such as an inorganic copper compound. The cupric compound has a water solubility of less than 50 mg/mL. For instance, the insoluble cupric compound may include inorganic copper salts, such as carbonate, bicarbonate, sulphate, nitrate, chloride, hydroxide, borate, fluoride or oxide.

Other examples of the insoluble cupric compound include copper oxides, such as cuprous oxide and cupric oxide, and copper salts, such as copper salts of fatty and rosin acids, copper ethylenediamine complex, copper triethanolamine complex, copper ethylenediaminetetraacetate, and copper thiocyanate. Still other examples of the copper containing compound include copper octanoate, copper diammonia diacetate complex, copper ethanolamine complex, copper naphthenate, and copper 8-quinolinoate. In one embodiment, the solubility of basic copper carbonate is 2×10⁻³ mg/mL. The solubility of copper hydroxide is 2.9 mg/mL. The solubility of copper pyrithione is 3.0×10⁻⁵ mg/mL. The solubility of copper acetylacetonate is 0.2 mg/mL.

In one example aspect, the insoluble cupric compound includes at least one of basic copper (II) carbonate, copper (II) hydroxide, copper 8-quinolinolate, copper (II) pyrithione, copper acetylacetonate, and copper (II) oxide. In a preferred example aspect, the insoluble cupric compound includes basic copper carbonate.

The insoluble cupric compounds described herein are not conventionally employed in paints and coating products due to the perceived ability of copper compounds to impact and, in some cases, entirely change the color of the resulting paint or coating. Of particular advantage, the present inventors have found that employing the insoluble cupric compounds herein in the polymer emulsion compositions according to the example aspects of the present disclosure surprisingly has little to no effect on the color of the resulting paint or coating. Thus, despite the presence of insoluble cupric compounds, the latex paint may advantageously be a “pure white” base paint or a paint that may be tinted to a desired color. In one example aspect, the insoluble cupric compound preferably includes a basic copper carbonate or is basic copper carbonate.

In one embodiment, the insoluble cupric compound may include micronized insoluble cupric compound particles. The micronized insoluble cupric compound particles may have a particle size of about 0.01 microns to about 25.0 microns, such as from about 0.01 microns to about 10 microns, such as from about 0.05 microns to about 10 microns, such as from about 0.1 microns to about 10.0 microns, such as from about 0.01 microns to about 1.0 micron, such as from about 0.05 microns to about 1.0 micron, such as from about 0.1 microns to about 1.0 micron, such as from about 0.2 microns to about 1.0 micron.

Advantageously, the insoluble cupric compound may be present in compositions of the present disclosure, including the polymer emulsion and antimicrobial composition, in an amount of less than about 4000 ppm Cu, such as less than about 2,500 ppm Cu, such as about less than about 1,000 ppm Cu, such as about less than 600 ppm Cu, such as less than about 500 ppm Cu, such as less than about 400 ppm Cu, such as less than about 300 ppm Cu, such as less than about 200 ppm Cu, such as less than about 100 ppm Cu, such as less than about 75 ppm Cu, such as less than about 50 ppm Cu, such as less than about 25 ppm Cu, such as about 10 ppm Cu.

In one embodiment, the insoluble cupric compounds disclosed herein may be added directly to the polymer emulsion composition and the antimicrobial composition. Thus, the insoluble cupric compound of the present disclosure is substantially free of a medium or matrix, such as glass. Further, the insoluble cupric compound may be present in the form of a dispersion or solution.

As noted above, the polymer emulsion composition and the antimicrobial composition includes a complementary colored pigment. For instance, the complementary colored pigment may include a red pigment. In one example aspect, the red pigment includes iron (II) oxide, diketopyrrolopyrrole, or dibromanthranthrone. Alternatively, the complementary colored pigment may include a white pigment, such as zinc oxide.

The complementary colored pigment may be present in the compositions of the present disclosure, including the polymer emulsion and antimicrobial composition, in the form of particles having a particle size 0.01 microns to 25.0 microns. In one embodiment particle size of the inorganic oxide compound used in the compositions disclosed herein can be between 0.01 to 10 microns, 0.05 to 10 microns, between 0.1 to 10.0 microns, between 0.01 to 1.0 micron, between 0.05 to 1.0 microns, between 0.1 to 1.0 microns, between 0.2 to 1.0 microns.

The complementary colored pigment may be present in the compositions disclosed herein at a concentration of about 10 ppm Cu to about 4,000 ppm Cu, such as from about 15 ppm Cu to about 900 ppm Cu, such as from about 50 ppm Cu to about 500 ppm Cu.

In another example aspect, notwithstanding in the type or amount of pigment employed, the complementary colored pigment may be present in micronized form, alone or in combination with a dispersing agent. For instance, in one embodiment the complementary colored pigment may have a particle size D50 of about 25 microns or less, such as about 10 microns or less, such as about 6 microns or less, such as about 5 microns or less, such as about 4 microns or less, such as about 3 microns or less, such as about 2 microns or less, such as about 1 micron or less.

In one embodiment, the insoluble cupric compound and the complementary colored pigment may be present in the polymer emulsion composition or antimicrobial composition at a weight ratio of from about 1000:1 to about 1:1000, such as from about 500:1 to about 1:500, such as from about 20:1 to about 1:20, such as from about 15:1 to about 1:15, such as from about 5:1 to about 1:5, such as from about 3:1 to about 1:3, such as from about 2:1 to about 1:2, such as about 1:1.

In one example aspect, the insoluble cupric compound and iron oxide are present in the polymer emulsion composition at a weight ratio of from about 10:1 to about 30:1, such as from about 15:1 to about 25:1.

In another example aspect, the insoluble cupric compound and zinc oxide are present in the polymer emulsion composition at a weight ratio of from about 10:1 to about 1:10, such as about 1:1.

As noted above, the polymer emulsion composition and the antimicrobial composition disclosed herein may optionally include a co-biocide. For instance, the co-biocide may include one or more of a quaternary ammonium compound, an isothiazolinone compound, a pyrithione compound, a triazine compound, a haloalkylnyl compound, a hydantoin compound, or a urea compound.

In another example aspect, the biocide includes a quaternary ammonium compound. For example, the biocide may include a quaternary ammonium halide, a quaternary ammonium carbonate/bicarbonate, or a benzyl ammonium halide.

Quaternary ammonium compounds, also known as “quats”, typically include at least one quaternary ammonium cation with an appropriate anion. Quats will generally have the following general formula:

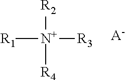

The groups R₁, R₂, R₃ and R₄ can vary within wide limits and examples of quaternary ammonium compounds that have antimicrobial properties will be well known to the person of ordinary skill in the art. Typically, two of R₁, R₂, R₃ and R₄ are lower alkyl, meaning having 1 to 4 carbon atoms, such as methyl, ethyl, propyl or butyl groups. In addition, two of R₁, R₂, R₃ and R₄ are longer chain alkyl groups of 6 to 24 carbon atoms, or a benzyl group. A is a monovalent anion or one equivalent of a polyvalent anion of an inorganic or organic acid. Suitable anions for A″ are in principle all inorganic or organic anions, in particular halides, for example chloride or bromide, carboxylates, sulfonates, phosphates or a mixture thereof.

In another example aspect, the quaternary ammonium compound may have the following R groups: R₁ is benzyl or C₆₋₁₈-alkyl, R₂ is C₁₋₁₈-alkyl or —[(CH₂)₂—O]ₙR₅ where n=1-20, R₃ and R₄ independently of one another are C₁₋₄-alkyl, R₅ is hydrogen or unsubstituted or substituted alkyl or phenyl, and A is a monovalent anion or one equivalent of a polyvalent anion of an inorganic or organic acid.

In another example aspect, the quaternary ammonium compound may include a dialkyl ammonium compound, such as a dimethyl dialkyl ammonium compound. In one embodiment, the dimethyl dialkyl ammonium compound may have between about 8 and about 12 carbon atoms, such as from about 8 to about 10 carbon atoms in each of the alkyl groups.

Examples of dimethyl dialkyl ammonium compounds which may be used as the biocide include dimethyl dioctyl ammonium compounds such as dimethyl dioctyl ammonium chloride, dimethyl didecyl ammonium compounds such as dimethyl didecyl ammonium chloride and the like. Mixtures of dimethyl dialkyl ammonium compounds may also be used and other anions, such as those described above may also be used. Commercially available dimethyl dialkyl ammonium compounds include, for example, BARDAC™ LF-80, BARDAC™ 22 and BARDAC™ 208M which are available from Arxada, LLC (formerly Lonza Specialty Ingredients).

In another example aspect, the co-biocide may include a quaternary ammonium carbonate, which can be represented by the following formula:

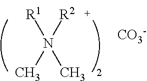

wherein R¹ is a C₁-C₂₀ alkyl or aryl-substituted alkyl group and R² is a C₈-C₂₀ alkyl group, and preferably wherein R¹ is the same as R₂ and R¹ is a C₈-C₁₂ alkyl group, as well as compositions further including the corresponding quaternary ammonium bicarbonate

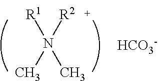

wherein R¹ is the same or a different C₁-C₂₀ alkyl or aryl-substituted alkyl group as above and R² is the same or a different C₈-C₂₀ alkyl group as above, but preferably wherein R¹ is the same as R₂ and R¹ is a C₅-C₁₂ alkyl group.

A quaternary ammonium carbonate/bicarbonate may include a di C₅-C₁₂ alkyl ammonium carbonate/bicarbonate. For example, in one particular example embodiment, the composition includes didecyl dimethyl ammonium carbonate and didecyl dimethyl ammonium bicarbonate.

In other example embodiments, however, the carbonate/bicarbonate salts of quaternary ammonium cations may be selected from dioctyldimethylammonium carbonate, decyloctyldimethylammonium carbonate, benzalkonium carbonate, benzethonium carbonate, stearalkonium carbonate, cetrimonium carbonate, behentrimonium carbonate, dioctyldimethylammonium bicarbonate, decyloctyldimethylammonium bicarbonate, benzalkonium bicarbonate, benzethonium bicarbonate, stearalkonium bicarbonate, cetrimonium bicarbonate, behentrimonium bicarbonate, and mixtures of one or more such carbonate salts.

Preferably, the quaternary ammonium compound may include one or more of didecyl dimethyl ammonium chloride, didecyl dimethyl ammonium carbonate, didecyl dimethyl ammonium bicarbonate, and alkyl dimethyl benzyl ammonium chloride.

In an example embodiment, the co-biocide may include a benzyl ammonium compound, such as an alkyl dimethyl benzyl ammonium compound. In general, the alkyl group may include from about 10 to about 18 carbon atoms, such as from about 12 to about 16 carbon atoms.

Examples of alkyl dimethyl benzyl ammonium compounds useable as the biocide include C₁₂ alkyl dimethyl benzyl ammonium chloride, C₁₄ alkyl dimethyl benzyl ammonium chloride, and C₁₆ alkyl dimethyl benzyl ammonium chloride. In addition, a mixture of these alkyl dimethyl benzyl ammonium compounds can be used. Commercially available alkyl dimethyl benzyl ammonium compounds include, for example BARQUAT® DM-80 and BARQUAT® 50-65B, which are available from Arxada, LLC (formly Lonza Specialty Ingredients). These commercially available alkyl dimethyl benzyl ammonium compounds are blends of C₁₂, C₁₄, and C₁₆ alkyl dimethyl benzyl ammonium chlorides. Generally, it is preferable that the alkyl dimethyl benzyl ammonium compound, when a blend, includes higher concentrations of C₁₂ alkyl and C₁₄ alkyl components than C₁₆ alkyl components. It is noted that other anions, including those mentioned above may also be used.

In another example aspect, the co-biocide includes an isothiazolone compound. Suitable isothiazolinones are represented by the following general formula:

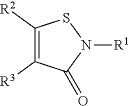

where: R¹ denotes hydrogen, optionally substituted C₁-C₁₈ alkyl, C₂-C₈ alkenyl or alkynyl, C₂-C₈ haloalkynyl, optionally substituted C₃-C₁₂ cycloalkyl, optionally substituted aralkyl having up to 10 carbon atoms, or optionally substituted aryl having up to 10 carbon atoms; R² and R³ independently denote hydrogen, halogen or C₁-C₄ alkyl; or together R² and R³ may provide a 1,2 benzisothiazolin-3-one group (i.e., R² and R³ may combine to form —(CH)₄—).

In one example aspect, R² and R³ independently denote chloro or hydrogen, or together R² and R³ may provide a 1,2 benzisothiazolin-3-one group.

Thus, in an example aspect, R¹ substituents are selected from hydrogen, methyl, ethyl, propyl, isopropyl, butyl, hexyl, octyl, cyclohexyl, 4-methoxyphenyl, 4-chlorophenyl, 3,4-dichlorophenyl, benzyl, 4-methoxybenzyl, 4-chlorobenzyl, 3,4-dichlorobenzyl, phenethyl, 2-(4-methoxyphenyl)ethyl, 2-(4-chlorophenyl)ethyl, 2-(3,4-dichlorophenyl)ethyl, hydroxymethyl, chloromethyl and chloropropyl.

In one such example aspect, the R¹ substituents in the compound of the above formula denotes hydrogen, optionally substituted C₁-C₁₈ alkyl, optionally substituted aralkyl having up to 10 carbon atoms, or optionally substituted aryl having up to 10 carbon atoms. In a further aspect, R¹ denotes hydrogen or optionally substituted C₁-C₁₈ alkyl. Additionally or alternatively, R¹ is hydrogen or C₁-C₈ alkyl, with hydrogen, methyl, butyl and octyl being the most preferred R¹ substituents.

Thus, in one aspect, isothiazolinones used in the polymer emulsion compositions and/or antimicrobial compositions according to the present disclosure are those represented by the general formula above, where R¹ denotes hydrogen or C₁-C₈ alkyl, and R² and R³ independently denote chloro or hydrogen, or together R² and R³ may provide a 1,2 benzisothiazolin-3-one group.

In one example aspect, isothiazolinones used in the polymer emulsion compositions and/or the antimicrobial compositions according to the present disclosure are those represented by the general formula above, where R¹ denotes hydrogen, methyl, butyl or octyl, and R² and R³ independently denote chloro or hydrogen, or together R² and R³ may provide a 1,2 benzisothiazolin-3-one group.

Furthermore, as discussed above, in one example aspect, the isothiazolinone of the formula above is a benzisothiazolinone of the following general formula:

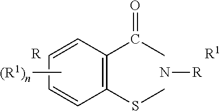

where, R is hydroxy, halogen (especially chlorine), C₁₋₄-alkyl or C₁₋₄-alkoxy; R₁ is as hereinbefore defined; and n is from 0 to 4. R, when present in an aspect, is located in one or both of the 5 and 6 positions of the phenyl ring of the benzisothiazolinone. However, in a further aspect, n is zero.

In one example aspect, a benzisothiazolinone of are those in which R¹ is H or C₁₋₅-alkyl, or where R¹ is H or C₃₋₅-alkyl. Examples of these compounds include, for example 1,2-benzisothiazolin-3-one, N-n-butyl-, N-methyl-, N-ethyl-, N-n-propyl-, N-isopropyl-, N-n-pentyl-, N-cyclopropyl-, N-isobutyl-, and N-tert-butyl-1,2-benzisothiazolin-3-one. Thus, in one aspect, the benzisothiazolinone is 1,2-benzisothiazolin-3-one.

For instance, in one example aspect, isothiazolones include, but are not limited to, methylisothiazol-3-one (MIT), 5-chloro-2-methyl-4-isothiazolin-3-one (CMIT), 4,5-dichloro-2-n-octyl-4-isothiazolin-3-one (DCOIT), octylisothiazol-3-one (OIT), 1,2-benzisothiazol-3(2H)-one (BIT), N-methyl-1,2-benzisothiazol-3-one (MBIT) and N-(n-butyl)-1,2-benzisothiazol-3-one (BBIT). Particularly preferred isothiazolones include, but are not limited to, methylisothiazol-3-one (MIT), 5-chloro-2-methyl-4-isothiazolin-3-one (CMIT), octylisothiazol-3-one (OIT), 1,2-benzisothiazol-3(2H)-one (BIT), N-methyl-1,2-benzisothiazol-3-one (MBIT) and N-(n-butyl)-1,2-benzisothiazol-3-one (BBIT). Even more preferred isothiazol-3-ones are 5-chloro-2-methyl-4-isothiazolin-3-one (CMIT), octylisothiazolone (OIT), 1,2-benzisothiazol-3(2H)-one (BIT) and N-(n-butyl)-1,2-benzisothiazol-3-one (BBIT), more preferably octylisothiazolone (OIT), 1,2-benzisothiazol-3(2H)-one (BIT) and N-(n-butyl)-1,2-benzisothiazol-3-one (BBIT), or combinations thereof.

Preferably, the isothiazolone compound may include one or more of 2-methyl-4-isothiazolin-3-one (MIT), 5-chloro-2-methyl-4-isothiazolin-3-one (CMIT), 4,5-dichloro-2-n-octylisothiazolin-3-one (DCOIT), 5-chloro-2-n-octyl-4-isothiazolin-3-one (COIT), 2-octyl-2H-isothiazolin-3-one (OIT), 1,2-benzothiazolin-3-one (BIT), N-methyl-1,2-benzisothiazolin-3-one (MBIT), and 2-butyl-1,2-benzisothiazolin-3(2H)-one (BBIT).

In another example aspect, the co-biocide includes a pyrithione compound. For instance, pyrithione compounds may include sodium pyrithione, zinc pyrithione, copper pyrithione, 1-hydroxy-2-pyridinone and pyrithione disulfide.

In another example aspect, the co-biocide includes a triazine compound. For example, the triazine compound may include 1,3,5-triazine.

In another example aspect, the co-biocide includes a haloalkylnyl compound, such as haloalkylnyl carbamate. For instance, the haloalkylnyl carbamate may include an iodoalkynl carbamate having the following general formula:

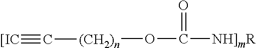

wherein m is 1, 2 or 3; n is 1, 2 or 3; and R is hydrogen (H); an unsubstituted or substituted alkyl, aryl, aralkyl alkylaryl, alkenyl, cycloalkyl, or cycloalkenyl or an alkoxy aryl all having from one to not more than 20 carbon atoms, and m and n may be the same or different.

Suitable R substituents for the iodoalkynyl carbamate compound include alkyls such as methyl, ethyl, propyl, n-butyl, t-butyl, pentyl (amyl), hexyl, heptyl, octyl, nonyl, decyl, dodecyl, octadecyl, cycloalkyls such as cyclohexyl, aryls, alkaryls and aralkyls such as phenyl, benzyl, tolyl, cumyl, halogenated alkyls and aryls, such as chlorobutyl and chlorophenyl, and alkoxy aryls such as ethoxyphenyl and the like. Thus, suitable carbamate compounds are selected from the group consisting of 3-iodo-2-propynyl butyl carbamate (IPBC), 3-iodo-2-propynyl hexyl carbamate (IPHC), 3-iodo-2-propynyl cyclohexyl carbamate (IPCC), 3-iodo-2-propynyl phenyl carbamate (IPPhC), 3-iodo-2-propynyl benzyl carbamate (IP Benzyl C), 3-iodo-2-propynyl propyl carbamate (IPPC), 4-iodo-3-butynyl propyl carbamate (IBPC), 3-iodo-2-propynyl-4-chloro phenyl carbamate (IPCI PhC), 3-iodo-2-propynyl-4-chloro butyl carbamate (IPCI BC) and mixtures thereof.

Preferably, the haloalkylnyl compound may include 3-iodo-2-propynyl butyl carbamate (IPBC).

In another example aspect, the co-biocide includes a hydantoin compound, such as an aldehyde. For instance, aldehydes may include formaldehyde and paraformaldehydes. Aldehyde forming compounds include imidazolidine compounds such as hydantoins, such as dimethylol dimethyl hydantoin (DMDMH).

In another example aspect, the co-biocide includes a urea derivative, such as an aryl urea compound. For example, the aryl urea compound may include (3-(3,4-dichlorophenyl)-1,1-dimethylurea (Diuron).

The complementary colored pigment may be present in the compositions disclosed herein at a concentration of about 10 ppm Cu to about 5,500 ppm Cu, such as from about 100 ppm Cu to about 5,000 ppm Cu, such as from about 500 ppm Cu to about 4,500 ppm Cu, such as from about 1,000 ppm Cu to about 3,500 ppm Cu.

Optionally, compositions disclosed herein may further includes an adjuvant compound. For instance, the adjuvant compound may include a guanidine enhancer having the structure of Compound I, Compound I having the formula:

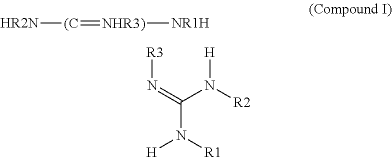

wherein, R3 is H, CN, C₁-C₃₀-alkyl, C₁-C₃₀-alkenyl, C₁-C₃₀-alkynyl, C₇-C₃₀-alkylaryl, or C₆-C₁₂-aryl; R1 is H, CN, C₁-C₃₀-alkyl, C₁-Cao-alkenyl, C₁-C₃₀-alkynyl, C₇-C₃₀-alkylaryl, or C₆-C₁₂-aryl; R2 is H, CN, C₁-C₃₀-alkyl, C₁-C₃₀-alkenyl, C₁-C₃₀-alkynyl, C₇-C₃₀-alkylaryl, or C₆-C₁₂-aryl; and wherein at least one of R3, R1, or R2 is C.

In one example aspect, the adjuvant compound and the insoluble cupric compound are present in the polymer emulsion composition at a weight ratio of from about 1:1 to about 1000:1.

In another example aspect, the adjuvant compound is present in the polymer emulsion composition at a concentration of about 100 ppm Cu to about 10,000 ppm Cu, such as from about 200 ppm Cu to about 10,000 ppm Cu, such as from about 1,000 ppm Cu to about 10,000 ppm Cu.

As used herein, references to chemical formulas use standard element symbols according to the periodic table (e.g., C denotes carbon, N denotes nitrogen, etc.). Further, references to chemical formula are based on standard bonding such that carbon can make up to four (4) bonds and nitrogen can make up to three (3) bonds unless otherwise specified. As such, references to CN, should be understood as indicating a cyano group where carbon includes a triple bond with nitrogen and the remaining carbon bond can indicate attachment of the cyano group to a chemical structure.

The guanidine enhancer includes one or more of the following: 1-cyanoguanidine, a salt of 1-cyanoguanidine, 2-cyanoguanidine (also referred to as dicyandiamide), and a salt of 2-cyanoguanidine. Both 1-cyanoguanidine and 2-cyanoguanidine are derivatives of Compound I, where R2 or R1 is CN and R3 is H, and R1 and R2 are H and R3 is CN, respectively. As should be understood, conversion between 1-cyanoguanidine and 2-cyanoguanidine may occur via tautomerization in aqueous solution or exposure to other proton donating solvents and so compositions that include only one tautomer, may display conversion over time to a mixture of both. Further, while exemplified using 1-cyanoguanidine and 2-cyanoguanidine, generally tautomer forms of species derived from Compound I can be included as guanidine enhancers in accordance with example implementations of the present disclosure. Tautomer forms of Compound I include structures (a) and (b), which have the formulas:

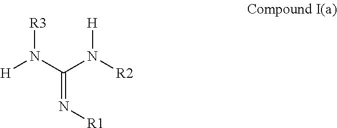

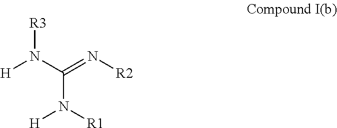

wherein, R3 is H, CN, C₁-C₃₀-alkyl, C₁-C₃₀-alkenyl, C₁-C₃₀-alkynyl, C₇-C₃₀-alkylaryl, or C₆-C₁₂-aryl; R1 is H, CN, C₁-C₃₀-alkyl, C₁-C₃₀-alkenyl, C₁-C₃₀-alkynyl, C₇-C₃₀-alkylaryl, or C₆-C₁₂-aryl; R2 is H, CN, C₁-C₃₀-alkyl, C₁-C₃₀-alkenyl, C₁-C₃₀-alkynyl, C₇-C₃₀-alkylaryl, or C₆-C₁₂-aryl; and wherein at least one of R3, R1, or R2 is CN.

In general, guanidine compounds can react with a proton donor to form a salt having a guanidinium cation carrying a positive charge, paired with an anion carrying a negative charge. Thus, in certain polymer emulsion compositions or antimicrobial compositions, the guanidine enhancer can be a salt of Compound I such as a salt of 1-cyanoguanidine and/or a salt of 2-cyanoguanidine.

Some examples of anions that can be included as the salt of 1-cyanoguanidine or the salt of 2-cyanoguanidine can include inorganic anions such as a halide (e.g., chloride, bromide, fluoride, iodide, etc.), nitrate, sulfate, etc. Alternatively or additionally, the anion can include an organic anion such as acetate or carboxylate anions derived from fatty acids such as octanoic acid, decanoic acid, or dodecanoic acid. Preferably, the guanidine enhancer includes 2-dicyandiamide.

In another example aspect, the adjuvant compound may include trifluoroacetic acid or a salt thereof. For instance, the adjuvant compound may include zinc ethyltrifluoroacetate.

In another example aspect, the adjuvant compound may include a tetramethylguanidine (TMG), such as 1,1,3,3-tetramethylguanidine and/or 2-tert-butyl-1,1,3,3-tetramethylguanidine.

In another example aspect, the adjuvant compound may include a cystamine enhancer, such as cystamine dihydrochloride.

In one example aspect, the pH of the polymer emulsion composition or the antimicrobial composition is from about 8.0 to about 9.5. As known in the art, pH builders, pH buffers, and other pH adjusting agents may be used to obtain and stabilize the above pH values.

The polymer emulsion composition of the present disclosure further includes a solvent. In the polymer emulsion of the present disclosure, the solvent may include a wide variety of suitable organic and/or inorganic solvents. In one example aspect, the solvent includes water.

In another example aspect, the polymer emulsion composition of the present disclosure may be a latex paint composition. Generally, the latex paint composition further includes a latex binder (e.g., a polymer including one or more acrylate, vinyl acetate, vinyl chloride, and/or styrene butadiene monomers). Optionally, the latex paint can further include an emulsifier and/or surfactant to improve distribution of the latex binder throughout the polymer emulsion composition. In this manner, the emulsifier and/or surfactant can be used to produce a more homogenous mixture that can provide a more even coating of the resulting latex paint coating. Optionally, the latex paint composition can include a thickening agent to adjust the viscosity of the latex paint to improve adhesion of the wet paint to an applicator (e.g., a brush or roller). Optionally, the latex paint composition can include a cosolvent (e.g., ethylene glycol) that can improve solubility of components of the latex paint composition.

In one example aspect, the polymer emulsion composition may constitute from about 5 wt. % to about 40 wt. % of the latex paint composition, such as from about 20 wt. % to about 30 wt. % of the latex paint composition.

Another aspect of example implementations can include a type of latex binder. The latex binder can include various polymers suitable for latex paints such as an acrylate (e.g., polymethylmethacrylate), that can be formed as a homopolymer or co-polymer. For example, a co-polymer can include incorporation of another monomer (e.g., butadiene styrene). In some implementations, the acrylate can be modified to include one or more nitrile groups. Thus, latex binders can include various acrylates, acrylate butadiene styrene copolymers, and acrylonitrile butadiene styrene copolymers. Additionally, these latex binders are provided for example purposes, and additional latex binders may be used alone or in combination with implementations of the disclosure.

As an example for illustration, an implementation of the present disclosure can include an latex paint including a latex binder with an acrylate. The acrylate can include a polymer or copolymer that includes one or more acrylate monomers. Example aspects of the acrylate polymer or copolymer can include a mass fraction of an acrylate monomer. For instance, the acrylate can include a copolymer that includes an acrylate monomer (e.g., methyl methacrylate) and a second monomer (e.g., butadiene styrene). The mass fraction of the acrylate monomer to the total weight of the copolymer can define the mass fraction. In some acrylates the mass fraction of acrylate monomer to the total weight of the copolymer can be no less than about twenty (20) wt % and no greater than about one hundred (100) wt % such as no less than about thirty (30) wt % and no greater than about eighty (80) wt %, no less than about forty (40) wt % and no greater than about seventy (70) wt %, or no less than about forty five (45) wt % and no greater than about sixty (60) wt % (e.g., one hundred (100) wt %, ninety five (95) wt %, ninety (90) wt %, eighty five (85) wt %, eighty (80) wt %, seventy five (75) wt %, seventy (70) wt %, sixty five (65) wt %, sixty (60) wt %, fifty five (55) wt %, or fifty (50) wt %). In particular, certain implementations can include an acrylate having a mass fraction of acrylate monomer to the total weight of acrylate greater than fifty (50) wt %.

In implementations of the present disclosure, the latex paint can include or may be formulated to include an amount of pigment. For instance, certain example latex paints can include a pigment, the pigment including titanium dioxide (TiO₂) at a concentration of no less than five (5) wt % TiO₂ and no greater than sixty (60) wt % TiO₂ based on the total weight of the latex paint. TiO₂ can be used to impart whiteness and/or opacity to example implementations and may also be included to build viscosity. In general, example implementations can include no less than five (5) wt % and no greater than sixty (60) wt % TiO₂ such as no less than fifteen (15) wt % and no greater than fifty five (55) wt % TiO₂, no less than twenty (20) wt % and no greater than fifty (50) wt % TiO₂ or no less than twenty five (25) wt % and no greater than forty five (45) wt % TiO₂.

In other example embodiments, the polymer emulsion composition of the present disclosure may be an adhesive.

In one example aspect, the antimicrobial composition according to the present disclosure may be manufactured and sold as a biocidal additive composition that includes the insoluble cupric compound, the complementary colored pigment, and one or both of the co-biocide and the adjuvant compound, and the additive composition may be substantially free of other materials. Thus, the additive composition may be a three-part additive composition or a four-part additive composition in such example embodiments. The three-part or four-part additive composition may be provided as an ingredient for forming a latex paint composition or a polymer emulsion composition. Moreover, the three-part additive composition or the four-part additive composition may be added to other components to form a latex paint composition or a polymer emulsion composition. As noted above, the polymer emulsion composition and/or the latex paint composition may advantageously provide broad spectrum antimicrobial control in the composition.

As evidence of potentiation of an insoluble cupric compound and the complementary colored pigment, the inhibitory concentration of the complementary colored pigment is lower in the presence of the insoluble cupric compound when tested against a target microorganism.

The preceding description is exemplary in nature and is not intended to limit the scope, applicability or configuration of the disclosure in any way. Various changes to the described embodiments may be made in the function and arrangement of the elements described herein without departing from the scope of the disclosure.

Unless defined otherwise, all technical and scientific terms used herein have the same meaning as commonly understood by one of ordinary skill in the art to which this invention is related.

As used in this application and in the claims, the singular forms “a”, “an”, and “the” include the plural forms unless the context clearly dictates otherwise. Additionally, the term “includes” means “comprises”. The methods and compositions of the present disclosure, including components thereof, can comprise, consist of, or consist essentially of the essential elements and limitations of the embodiments described herein, as well as any additional or optional ingredients, components or limitations described herein or otherwise useful in biocidal compositions.

Unless otherwise indicated, all numbers expressing quantities of ingredients, properties such as molecular weight, percentages, and so forth, as used in the specification or claims are to be understood as being modified by the term “about”. Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

As used herein, “optional” or “optionally” means that the subsequently described material, event or circumstance may or may not be present or occur, and that the description includes instances where the material, event or circumstance is present or occurs and instances in which it does not. As used herein, “w/w %” and “wt %” mean by weight as relative to another component or a percentage of the total weight in the composition.

The term “about” is intended to mean approximately, in the region of, roughly, or around. When the term “about” is used in conjunction with a numerical range, it modifies that range by extending the boundaries above and below the numerical values set forth. Unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

The term “substantially free of” when used to describe the amount of substance in a material is not to be limited to entirely or completely free of and may correspond to a lack of any appreciable or detectable amount of the recited substance in the material, Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

The phrase “effective amount” means an amount of a compound that promotes, improves, stimulates, or encourages a response to the particular condition or disorder or the particular symptom of the condition or disorder.

The terms “potentiator” and “adjuvant” as used herein refers to an additive that can affect the performance of an active compound when used in combination with the active compound but does not exhibit any biocidal activity itself and/or does not exhibit significant biocidal activity itself in the compositions of the invention.

The term “antimicrobial” as used herein refers to any chemical compound that prevents the growth of organisms on a coating surface and/or that prevents the growth of organisms “in-can” in a paint or coating prior to surface application.

The terms “antifouling paint” and “antifouling coating” are used interchangeably herein.

As used herein, the terms “first”, “second”, and “third” may be used interchangeably to distinguish one component from another and are not intended to signify location or importance of the individual components.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “D50” or “D50 particle size” refers to the volume median particle size, where 50% of the particles of the sample volume have a size below that range or value.

Analogously, as used herein, the term “D95” or “D95 particle size” refers to a value where 95% of the particles of the sample volume have a size below that range or value.

As used herein, the term “particle size” as used herein, unless specifically stated otherwise, refers to the median particle size D50. Particle size can be measured using a laser scattering particle size analyzer, such as a HORIBA LA 910 particle size analyzer.

The terms “median particle size” and “average particle size” and D50 are used herein interchangeably.

As used herein, the term “micronized” as used herein means a median particle size (D50) in the range of 0.01 to 25 microns.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Furthermore, certain aspects of the present disclosure may be better understood according to the following examples, which are intended to be non-limiting and exemplary in nature. Moreover, it will be understood that the compositions described in the examples may be substantially free of any substance not expressly described.

### EXAMPLES

### Example 1

The compatibilities of copper compounds in paint were evaluated via visual assessment of dry film appearance of a flat wall paint (50% PVC, 35% Solid Vol, 45 g/L VOC, Table 1). Micronized basic copper carbonate (μBCC containing copper: Cu) dispersion or copper sulfate (CuSO₄) aqueous solution (2 gram of soluble CuSO₄ was dissolved into 38 g water for 5 wt % solution) were added into the flat wall paint to achieve 600 ppm level of Cu. The test paints were mixed at 1500 rpm for 10 minute and then equilibrated overnight. Test paints were drawn down on sealed Leneta chart to achieve 5 mil wet film thickness and then air dried for 24 hours. The coating appearance was visually inspected for any defects such as grits formed due to incompatibility.

TABLE 1
Flat Wall Paint Composition

| Material | Weight (g) |
|---|---|
| Water | 350.5 |
| Defoamer | 4.6 |
| Dispersant | 10.6 |
| Surfactant | 1.1 |
| Ethylene Glycol | 29.3 |
| Coalescent | 3.8 |
| Cellulose | 3.0 |
| Attapulgite | 5.9 |
| pH Adjuster | As Needed |
| Kaolin | 87.8 |
| Nepheline Syenite | 146.3 |
| Titanium Dioxide | 152.1 |
| 100% Acrylic Emulsion | 205.0 |
| Total Weight | 1000.0 |

TABLE 2
Compatibilities of Copper Compounds in Paint

| Blank | μBCC | CuSO₄ |
|---|---|---|
| 0 ppm Cu | 600 ppm Cu | 600 ppm Cu |
| Compatible (no grits) | Compatible (no grits) | Incompatible (many grits) |

As shown in Table 2, water-insoluble μBCC is compatible but water-soluble CuSO₄ is incompatible in this acrylic paint. In the latter case, soluble copper cation reacts with acrylic acid in the acrylic latex to form insoluble copper acrylate compound which results in the grit formation in the dry film.

### Example 2. Color Impact of Copper Compound

The impacts of copper compounds on the color of dry paint film were studied in a flat wall paint (50% PVC, 35% Solid Vol, 45 g/L VOC, Table 1). 5 gram of insoluble copper compound was dispersed into a mixture of 44.5 g water and 0.5 g Tamol 731A dispersant and then mixed at 1500 rpm for 10 minutes. 2 grams of soluble copper compound was dissolved into 38 g water. The resulting dispersion of insoluble copper compound (10 wt %) and solution of soluble copper compound (5 wt %) were added into the paint to achieve 300 and 600 ppm level of Cu. The test paints were mixed at 1500 rpm for 10 minute and then equilibrated overnight. The test paints were drawn down on sealed Leneta chart to achieve 5 mil wet film thickness and then air dried for 24 hours. The colors of dry films were measured by a BYK spectro-guide colorimeter and the color changes (ΔE, ΔE′) were calculated as follow.
L: the lightness of the color (L*=0 yields black and L*=100 indicates diffuse white; specular white may be higher);
a: the position between red/magenta and green (a*, negative values indicate green while positive values indicate magenta); and
b: the position between yellow and blue (b*, negative values indicate blue and positive values indicate yellow).
ΔB=(ΔL²+Δa²+Δb²)^{0.5} (overall) and ΔE′=(Δa²+Δb²) 0.5 (color only); ΔE and ΔE′<1.0-2.0: color change not visually perceivable.

TABLE 3
Impact of Copper Compound on Color of Dry Paint Film

| Type of Copper | Cu Level | Soluble | | | | | |
|---|---|---|---|---|---|---|---|
| Compound | (ppm) | (Y/N) | L | a | b | ΔE | ΔE′ |
| Blank Control | 0 | NA | 97.04 | −0.78 | 2.03 | | |
| Copper (II) Oxide | 300 | N | 96.97 | −0.81 | 2.04 | 0.08 | 0.03 |
| | 600 | N | 96.83 | −0.81 | 1.98 | 0.22 | 0.06 |
| Micronized Basic Copper | 300 | N | 96.12 | −2.19 | 0.81 | 2.08 | 1.86 |
| (II) Carbonate | 600 | N | 95.71 | −2.79 | 0.37 | 2.93 | 2.61 |
| Copper (II) Hydroxide | 300 | N | 95.96 | −2.49 | 0.58 | 2.49 | 2.24 |
| | 600 | N | 95.65 | −2.90 | 0.18 | 3.14 | 2.81 |
| Copper (II) Sulfate | 300 | Y | 96.28 | −2.42 | 0.92 | 2.12 | 1.98 |
| | 600 | Y | 95.70 | −3.66 | 0.31 | 3.61 | 3.35 |
| Copper (II) Pyrithione | 300 | N | 94.43 | −1.61 | 4.28 | 3.54 | 2.40 |
| | 600 | N | 92.77 | −1.96 | 5.10 | 5.39 | 3.29 |

As shown in Table 3, μBCC dispersion gives less color change than other colored cupric compounds at 300 and 600 ppm Cu level, except for cupric oxide. While not wishing to be bound to any particular theory, it is believed that the reduced color change by cupric oxide may be largely due to the poor dispersibility of cupric oxide in the paint.

### Example 3

The color change of the flat wall paint (50% PVC, 35% Solid Vol, 45 g/L VOC, Table 1) comprising μBCC (green) can be mitigated by incorporation of iron oxide pigment (red: complementary color) and zinc oxide (ZnO). 10 gram of ZnO was dispersed into a mixture of 29.5 g water and 0.5 g Tamol 731A dispersant and then mixed at 1500 rpm for 10 minutes. μBCC, Colanyl Oxide Red B130 and the above ZnO dispersions (25 wt %) were added into the flat wall paint to achieve the target level of Cu, Oxide Red and ZnO. The test paints were mixed at 1500 rpm for 10 minute and then equilibrated overnight. The test paints were drawn down on sealed Leneta chart to achieve 5 mil wet film thickness and then air dried for 24 hours. The colors of dry films were measured by a BYK spectro-guide colorimeter and the color changes (ΔE, ΔE′) were calculated.

TABLE 4
Reduction of Color Change in μBCC-containing
Dry Paint Films at High Cu Level

| | Colanyl | | | | | | | | | |
|---|---|---|---|---|---|---|---|---|---|---|
| Cu | Oxide Red | ZnO | | | | | | | | |
| (ppm) | (ppm) | (ppm) | L | a | b | ΔL | Δa | Δb | ΔE | ΔE′ |
| 0 | 0 | 0 | 97.16 | −0.80 | 1.94 | 0.00 | 0.00 | 0.00 | 0.00 | 0.00 |
| 1150 | 0 | 0 | 96.14 | −2.93 | 1.00 | −1.02 | −2.13 | −0.94 | 2.54 | 2.33 |
| 1150 | 10 | 0 | 95.98 | −2.57 | 1.04 | −1.18 | −1.77 | −0.90 | 2.31 | 1.99 |
| 1150 | 25 | 0 | 95.81 | −2.33 | 1.19 | ~1.35 | −1.53 | −0.75 | 2.17 | 1.70 |
| 1150 | 50 | 0 | 95.31 | −1.69 | 1.26 | −1.85 | −0.89 | −0.68 | 2.16 | 1.12 |
| 1150 | 100 | 0 | 94.69 | −0.82 | 1.53 | −2.47 | −0.02 | −0.41 | 2.50 | 0.41 |
| 1150 | 200 | 0 | 93.56 | 0.68 | 1.85 | −3.60 | 1.48 | −0.09 | 3.89 | 1.48 |
| 1150 | 50 | 1007 | 95.62 | −1.01 | 1.66 | −1.67 | −0.23 | −0.49 | 1.76 | 0.54 |
| 1150 | 50 | 1992 | 95.61 | −0.87 | 1.73 | −1.68 | −0.09 | −0.42 | 1.73 | 0.43 |
| 1150 | 49 | 3983 | 95.63 | −0.84 | 1.77 | −1.66 | −0.06 | −0.38 | 1.70 | 0.38 |
| 1150 | 76 | 987 | 95.16 | −0.45 | 1.82 | −2.13 | 0.33 | −0.33 | 2.18 | 0.47 |
| 1150 | 75 | 2020 | 95.21 | −0.38 | 1.87 | −2.08 | 0.40 | −0.28 | 2.14 | 0.49 |
| 1150 | 74 | 3982 | 95.27 | −0.37 | 1.91 | −2.02 | 0.41 | −0.24 | 2.08 | 0.48 |
| 1150 | 99 | 999 | 94.96 | −0.12 | 1.89 | −2.33 | 0.66 | −0.26 | 2.44 | 0.71 |
| 1150 | 100 | 1982 | 94.95 | 0.00 | 1.96 | −2.34 | 0.78 | −0.19 | 2.47 | 0.80 |
| 1150 | 101 | 3987 | 95.01 | 0.08 | 2.01 | −2.28 | 0.86 | −0.14 | 2.44 | 0.87 |

As shown in Table 4, the color change in μBCC-containing dry paint film is visually perceivable (ΔE and ΔE′>2.0) at 1150 ppm Cu. The color change can be reduced to visually unperceivable (ΔE and ΔE′<2.0) by addition of Colanyl Oxide Red B130 (100 ppm) or the combination of Colanyl Oxide Red B130 (50 ppm) and ZnO (2000 ppm).

### Example 4

The antibacterial efficacies of copper-containing composition in dry paint film were evaluated using a modified JIS Z2801 method (Antimicrobial Product-Test for Antimicrobial Activity and Efficacy: 2000) by reducing contact time from 24 hour to 2 hour and including Pseudomonas aeruginosa as an additional bacteria. In brief, μBCC dispersion and optional ZnO dispersion (25 wt %) were added into a flat wall paint (50% PVC, 35% Solid Vol, 45 g/L VOC, Table 1) for target Cu and ZnO level, respectively. The paints were brushed onto the sterilized plastic filter paper. Each side of the filter paper was painted twice and the resulting coated paper was dried at ambient condition for 3 days. The dried coatings were then leached against 10 L water for 24 hours (4 water changes for the first 8 hour). Each of three (3) bacterial inoculum (0.4 mL): Escherichia coli (ATCC 8739), Staphylococcus aureus (ATCC 6538), Pseudomonas aeruginosa (ATCC 15442) was used to inoculate the dry film (40 mm×40 mm) of test paint to achieve 1.0 to 4.0×10⁵ cfm/mL of inoculum concentration per each bacteria on dry surface of each test paint. The test paints were incubated at 35±1° C. and 90% relative humidity (RH) for 2 hour. The degrees of bacterial contamination of all samples were determined relative to blank paint via viable cell count of bacteria by agar plate culture method.

TABLE 5
Summary Table of Antibacterial Efficacies
of μBCC and ZnO in Paint

| Cu | ZnO | Staphylococcus aureus (ATCC 6538; gram positive) | | | | |
|---|---|---|---|---|---|---|
| Level | Level | 0 hr | 2 hr Contact Time | | | |
| ppm | ppm | Rep 0 | Avg | Log10 | Log10 ↓ | % ↓ |
| 0 | 0 | 1.6E+05 | 9.9E+04 | 5.00 | | |
| 165 | 0 | | 6.3E+01 | 1.80 | 3.20 | 99.936 |
| 330 | 0 | | <2.0E+01 | <1.30 | ≥3.70 | ≥99.980 |
| 824 | 0 | | <4.0E+01 | <1.60 | ≥3.40 | ≥99.960 |
| 1650 | 0 | | <1.0E+01 | <1.00 | ≥4.00 | ≥99.990 |
| 83 | 82 | | 8.9E+03 | 3.95 | 1.05 | 91.013 |
| 165 | 161 | | <1.0E+02 | <2.01 | ≥2.99 | ≥99.896 |
| 412 | 414 | | <1.7E+01 | <1.22 | ≥3.78 | ≥99.983 |
| 824 | 829 | | <1.3E+01 | <1.12 | ≥3.88 | ≥99.987 |

| Cu | ZnO | Pseudomonas aeruginosa (ATCC 15442; gram negative) | | | | |
|---|---|---|---|---|---|---|
| Level | Level | 0 hr | 2 hr Contact Time | | | |
| ppm | ppm | Rep 0 | Avg | Log10 | Log10 ↓ | % ↓ |
| 0 | 0 | 1.5E+05 | 1.9E+04 | 4.28 | | |
| 165 | 0 | | 1.2E+03 | 3.08 | 1.20 | 93.632 |
| 330 | 0 | | 1.3E+03 | 3.13 | 1.15 | 92.912 |
| 824 | 0 | | <4.7E+01 | <1.67 | ≥2.61 | ≥99.754 |
| 1650 | 0 | | 2.7E+01 | 1.43 | 2.85 | 99.860 |
| 83 | 82 | | 6.9E+03 | 3.84 | 0.44 | 63.860 |
| 165 | 161 | | 1.0E+03 | 3.01 | 1.27 | 94.667 |
| 412 | 414 | | <7.7E+01 | <1.88 | ≥2.40 | ≥99.596 |
| 824 | 829 | | <1.0E+01 | <1.00 | ≥3.28 | ≥99.947 |

| Cu | ZnO | Escherichia coli (ATCC 8739; gram negative) | | | | |
|---|---|---|---|---|---|---|
| Level | Level | 0 hr | 2 hr Contact Time | | | |
| ppm | ppm | Rep 0 | Avg | Log10 | Log10 ↓ | % ↓ |
| 0 | 0 | 1.9E+05 | 7.1E+04 | 4.85 | | |
| 165 | 0 | | <5.7E+01 | <1.75 | ≥3.10 | ≥99.920 |
| 330 | 0 | | <1.0E+01 | <1.00 | ≥3.85 | ≥99.986 |
| 824 | 0 | | <4.0E+01 | <1.60 | ≥3.25 | ≥99.944 |
| 1650 | 0 | | <1.0E+01 | <1.00 | ≥3.85 | ≥99.986 |
| 83 | 82 | | 1.3E+04 | 4.10 | 0.75 | 82.347 |
| 165 | 161 | | <1.7E+01 | <1.22 | ≥3.63 | ≥99.977 |
| 412 | 414 | | <1.0E+01 | <1.00 | ≥3.85 | ≥99.986 |
| 824 | 829 | | <1.0E+01 | <1.00 | ≥3.85 | ≥99.986 |

The antibacterial efficacies of copper-containing compositions in dry film of the flat paint are given in Table 5. >3 Log₁₀ or >99.9% reduction in bacteria count is achieved at 1650 ppm Cu when μBCC is used alone or at 825 ppm Cu and 825 ppm ZnO when μBCC is used in combination with ZnO.

### Example 5

The antibacterial efficacies of copper-containing composition in dry paint film were evaluated using a modified JIS Z2801 method (Antimicrobial Product-Test for Antimicrobial Activity and Efficacy: 2000) by reducing contact time from 24 hour to 2 hour, including Pseudomonas aeruginosa as an additional bacteria and increasing inoculum strength to 5.0 to 10.0×10⁷ cfm/mL. In brief, μBCC dispersion was added into a Quat-containing matte wall paint (41.5% Solid Vol, <50 g/L VOC, 0.52% alkyl (50% C₁₄, 10% C₁₆, 40% C₁₂) dimethyl benzyl ammonium chloride) for target Cu and Quat level respectively. The paints were brushed onto the sterilized plastic filter paper. Each side of the filter paper was painted twice and the resulting coated paper was dried at ambient condition for 3 days. The dried coatings were then leached against 10 L water for 24 hours (4 water changes for the first 8 hour). Each of three (3) bacterial inoculum (0.4 mL): Escherichia coli (ATCC 8739), Staphylococcus aureus (ATCC 6538), Pseudomonas aeruginosa (ATCC 15442) was used to inoculate the dry film (40 mm×40 mm) of test paint to achieve 5.0 to 10.0×10⁷ cfm/mL of inoculum concentration per each bacteria on dry surface of each test paint. The test paints were incubated at 35±1° C. and 90% RH for 2 hour. The degrees of bacterial contamination were determined relative to blank paint via viable cell count of bacteria by agar plate culture method.

The antibacterial efficacies of copper-containing compositions in dry film of this matte paint are given in Table 6, which demonstrates improved efficacy by addition of μBCC into the Quat-containing paint. Particularly, additional >3 Log₁₀ or >99.9% reduction in bacteria count is achieved for Pseudomonas when 330 ppm Cu is combined with 5200 ppm Quat.

TABLE 6
Summary Table of Antibacterial Efficacies
of μBCC and Quat in Paint

| | | Staphylococcus aureus (ATCC 6538; gram positive) | | | | |
|---|---|---|---|---|---|---|
| Quat | Cu | 0 hr | 2 hr Contact Time | | | |
| ppm | ppm | Rep 0 | Avg | Log10 | Log10 ↓ | % ↓ |
| 5200 | 0 | 7.6E+07 | <1.5E+02 | <2.19 | | |
| 5195 | 330 | | <1.3E+01 | <1.12 | ≤1.07 | ≤91.30 |
| 5187 | 825 | | <2.0E+02 | <2.29 | NR | NR |

| | | Pseudomonas aeruginosa (ATCC 15442; gram negative) | | | | |
|---|---|---|---|---|---|---|
| Quat | Cu | 0 hr | 2 hr Contact Time | | | |
| ppm | ppm | Rep 0 | Avg | Log10 | Log10 ↓ | % ↓ |
| 5200 | 0 | 4.7E+07 | 2.9E+05 | 5.46 | | |
| 5195 | 330 | | <2.3E+02 | <2.36 | ≥3.10 | ≥99.92 |
| 5187 | 825 | | <4.1E+02 | <2.61 | ≥2.85 | ≥99.86 |

| | | Escherichia coli (ATCC 8739; gram negative) | | | | |
|---|---|---|---|---|---|---|
| Quat | Cu | 0 hr | 2 hr Contact Time | | | |
| ppm | ppm | Rep 0 | Avg | Log10 | Log10 ↓ | % ↓ |
| 5200 | 0 | 7.2E+07 | 1.4E+02 | 2.16 | | |
| 5195 | 330 | | <1.0E+01 | <1.00 | ≥1.16 | ≥93.02 |
| 5187 | 825 | | <1.0E+01 | <1.00 | ≥1.16 | ≥93.02 |

### Example 6

The antibacterial efficacies of copper-containing composition in dry paint film were evaluated using an interim EPA method (Interim Method for Evaluating the Efficacy of Antimicrobial Surface Coatings: Oct. 2, 2020). In brief, μBCC dispersion was added into a flat wall paint (38% Solid Vol, <50 g/L VOC) for target Cu level. The paints were drawn-down onto the sterilized steel substrate (1 inch by 1 inch of AISI type 304 stainless steel). The resulting coated substrate was dried at ambient condition for at least 24 hours. Each of two (2) bacterial inoculum (20 mL): Staphylococcus aureus (ATCC 6538) and Pseudomonas aeruginosa (ATCC 15442) was used to inoculate the dry film of test paint to achieve 10⁴ to 10⁵ cfm/carrier of each bacteria on dry surface of each test paint. The test paints were incubated at 22° C. and 30-40% RH for 2 hours. The degrees of bacterial contamination were determined via viable cell count for antibacterial efficacy relative to the uncoated substrate.

TABLE 7
Summary Table of Antibacterial Efficacies of μBCC in Paint

| | | Staphylococcus aureus (ATCC 6538; gram positive) | | | | |
|---|---|---|---|---|---|---|
| | Cu | 0 hr | 2 hr Contact Time | | | |
| | ppm | Rep 0 | Avg | Log10 | Log10 ↓ | % ↓ |
| Uncoated | | NT | 9.2E+04 | 4.96 | | |
| Blank | 0 | | 4.4E+02 | 2.64 | 2.32 | 99.5214% |
| μBCC-dosed | 1670 | | 6.6E+01 | 1.82 | 3.15 | 99.9287% |

| | | Pseudomonas aeruginosa (ATCC 15442; gram negative) | | | | |
|---|---|---|---|---|---|---|
| | μBCC | 0 hr | 2 hr Contact Time | | | |
| | ppm | Rep 0 | Avg | Log10 | Log10 ↓ | % ↓ |
| Uncoated | | NT | 2.8E+04 | 4.45 | | |
| Blank | 0 | | 1.1E+02 | 2.05 | 2.40 | 99.6019% |
| μBCC-dosed | 1670 | | 1.0E+00 | 0.00 | 4.45 | 99.9964% |

The antibacterial efficacies of copper-containing compositions in dry film of this flat paint are given in Table 7. Compared with the blank paint, the addition of μBCC (1670 ppm Cu) achieves >3 Log₁₀ or >99.9% reduction in bacteria count for passing EPA criteria of supplementary antimicrobial product.

### Example 7

The antibacterial efficacies of copper-containing composition in dry paint film were evaluated using an interim EPA method (Interim Method for Evaluating the Efficacy of Antimicrobial Surface Coatings: Oct. 2, 2020). In brief, μBCC dispersion was added into a matte wall paint (41.5% Solid Vol, <50 g/L VOC, 0.52% alkyl (50% C₁₄, 10% C₁₆, 40% C₁₂) dimethyl benzyl ammonium chloride) for target Cu and Quat level, respectively. The paints were drawn-down onto the sterilized steel substrate (1 inch by 1 inch of AISI type 304 stainless steel). The resulting coated substrate was dried at ambient condition for at least 24 hours. Some of the dried coated substrates were further subject to dry and chemical abrasion for 1 week residual efficacy claim. As for dry abrasion, the coated substrate was exposed to 10 cycles of dry abrasion by a Scotch Brite Non-Scratch Scrub Sponge using a BYK Gardner-Scrub machine, each of which comprises 16 single passes. As for chemical abrasion, the scrub sponge was soaked in sodium hypochlorite (2000 ppm NaOCl) solution and EPA-registered Quat-containing Nugen™ MB⁵N-256 (256× dilution) disinfectant prior to the abrasion. The coated substrate was exposed to 10 cycles of chemical abrasion by the soaked scrub sponge, each of which comprises 8 single passes. After rinsing and drying to remove the residual NaOCl and Quat, each of two (2) bacterial inoculum (20 mL): Staphylococcus aureus (ATCC 6538) and Pseudomonas aeruginosa (ATCC 15442) was used to inoculate the dry film of test paint to achieve 10⁴ to 10⁵ cfm/carrier of bacteria on dry surface of each test paint. The test paints were incubated at 22° C. and 30-40% RH for 2 hours. The degrees of bacterial contamination were determined via viable cell count for antibacterial efficacy relative to the uncoated substrate.

TABLE 8
Summary Table of Antibacterial Efficacies of μBCC and Quat in Paint

| | | Staphylococcus aureus (ATCC 6538; gram positive) | |
|---|---|---|---|
| Quat | Cu | 0 hr | 2 hr Contact Time |

| Sample | ppm | ppm | Rep 0 | Avg | Log10 | Log10 ↓ | % ↓ |
|---|---|---|---|---|---|---|---|
| Uncoated | | | NT | 1.0E+5 | 5.00 | | |
| Unexposed | 5200 | 0 | | 1.0E+0 | 0.00 | 5.00 | 99.9990% |
| Dry Abraded | 5200 | 0 | | 1.0E+0 | 0.00 | 5.00 | 99.9990% |
| Quat Abraded | 5200 | 0 | | N/A | N/A | N/A | N/A |
| NaOCl Abraded | 5200 | 0 | | 1.0E+0 | 0.00 | 5.00 | 99.9990% |
| Unexposed | 5174 | 1670 | | 1.0E+0 | 0.00 | 5.00 | 99.9990% |
| Dry Abraded | 5174 | 1670 | | 1.0E+0 | 0.00 | 5.00 | 99.9990% |
| Quat Abraded | 5174 | 1670 | | 1.0E+0 | 0.00 | 5.00 | 99.9990% |
| NaOCl Abraded | 5174 | 1670 | | 1.0E+0 | 0.00 | 5.00 | 99.9990% |

| | | | Pseudomonas aeruginosa (ATCC 15442; gram negative) | | | | |
|---|---|---|---|---|---|---|---|
| | Quat | Cu | 0 hr | 2 hr Contact Time | | | |
| Sample | ppm | ppm | Rep 0 | Avg | Log10 | Log10 ↓ | % ↓ |
| Uncoated | | | NT | 2.8E+4 | 4.44 | | |
| Unexposed | 5200 | 0 | | 1.7E+3 | 3.23 | 1.21 | 93.8340% |
| Dry Abraded | 5200 | 0 | | 1.0E+2 | 2.01 | 2.43 | 99.6285% |
| Quat Abraded | 5200 | 0 | | 1.1E+2 | 2.06 | 2.38 | 99.5831% |
| NaOCl Abraded | 5200 | 0 | | 1.4E+0 | 0.16 | 4.28 | 99.9994% |
| Unexposed | 5174 | 1670 | | 1.0E+0 | 0.00 | 4.44 | 99.9964% |
| Dry Abraded | 5174 | 1670 | | 1.0E+0 | 0.00 | 4.44 | 99.9964% |
| Quat Abraded | 5174 | 1670 | | 1.0E+0 | 0.00 | 4.44 | 99.9964% |
| NaOCl Abraded | 5174 | 1670 | | 3.5E+0 | 0.54 | 3.90 | 99.9987% |

The antibacterial efficacies of copper-containing compositions in dry film of this flat paint are given in Table 8, which demonstrates improved efficacy by addition of μBCC into the Quat-containing paint. Particularly, the combination of μBCC (1670 ppm) and Quat (5200 ppm) achieves >3 Log₁₀ or >99.9% reduction of both Staphylococcus and Pseudomonas after dry and NaOCI/Quat abrasion for enabling 1 week residual efficacy claim per EPA criteria.

### Example 8

The antifungal efficacies of copper-containing composition in dry paint film were evaluated using an ASTM method (Standard Test Method for Resistance to Growth of Mold on the Surface of Interior Coatings in an Environmental Chamber), In brief, μBCC dispersion, and optional Quat (quaternary ammonium compound), were added into a flat wall paint (50% PVC, 35% Solid Vol, 45 g/L VOC, Table 1) for target Cu and Quat level, respectively. Two coatings were brushed onto both faces and all edges of wood panel (allowing 1 day between coats). The resulting coated panels were dried at 23±2° C. and 50±5% relative humidity for 4 days. Greenhouse soil was inoculated by Aspergillus niger (ATCC 6275), Aureobasidium pullulans (ATCC 9348) and Penicillium citrinum (ATCC 9849). In the environmental chamber, the dried coated panels were hung vertically with the bottom approximately 3 inch above the surface of the inoculated soil and with sufficient spacing to allow free circulation of air and to prevent contact between panels or with wall surfaces. The coated panels were exposed to 32.5±1° C. and 95±3% relative humidity in the environmental chamber for 4 weeks. The degrees of fungal contamination were assessed using the rating scale in Table 9.

TABLE 9
Rating Scale of Fungal Growth

| Rating | Description | Note |
|---|---|---|
| 10 | 0% defacement | Pass |
| 9 | 1-10% defacement | Pass |
| 8 | 11-20% defacement | Pass |
| 7 | 21-30% defacement | Fail |
| 6 | 31-40% defacement | Fail |
| 5 | 41-50% defacement | Fail |
| 4 | 51-60% defacement | Fail |
| 3 | 61-70% defacement | Fail |
| 2 | 71-80% defacement | Fail |
| 1 | 81-90% defacement | Fail |
| 0 | 91-100% defacement | Fail |

The antifungal efficacies of copper-containing additives in dry film of this flat wall paint are given in Table 10. μBCC passes the test at 333 ppm Cu but fails at 167 ppm Cu level while 2 Quats fails the test at 2000 ppm levels. The combinations of ABCC (167 ppm Cu) and Quat (2000 ppm) pass the test while each individual component fails the test at these levels.

TABLE 10
Summary Table of Antifungal Efficacies of μBCC and Quat in Paint

| | Cu | | Quat | |
|---|---|---|---|---|
| Cu | Level | | Level | Avg |
| Additive | (ppm) | Quat Additive | (ppm) | Rating |
| None | | None | | 1.7 |
| μBCC | 167 | None | | 7.7 |
| μBCC | 333 | None | | 9.3 |
| None | | N,N-Didecyl-N,N-dimethylammonium | 2000 | 3.3 |
| | | carbonate/bicarbonate | | |
| None | | Lauryl Dimethyl Amine | 2000 | 2.7 |
| μBCC | 167 | N,N-Didecyl-N,N-dimethylammonium | 2000 | 8.7 |
| | 333 | carbonate/bicarbonate | 2000 | 9.0 |
| | 167 | Lauryl Dimethyl Amine | 2000 | 8.7 |
| | 333 | | 2000 | 9.0 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer emulsion composition, the composition comprising:
a latex binder;
an insoluble cupric compound; and
a complementary colored pigment,
wherein the insoluble cupric compound is present in the polymer emulsion composition in an amount less than about 4000 ppm Cu.

2. The polymer emulsion composition of claim 1, wherein the insoluble cupric compound comprises one or more of basic copper (II) carbonate, copper (II) hydroxide, copper 8-quinolinolate, copper (II) pyrithione, copper acetylacetonate, and copper (II) oxide.

3. The polymer emulsion composition according to claim 1 or 2, wherein the complementary colored pigment is a red pigment.

4. The polymer emulsion composition according to claim 1 or 2, wherein the complementary colored pigment is a white pigment.

5. The polymer emulsion composition according to any one of claims 1 through 4, wherein the complementary colored pigment comprises one or more of iron (III) oxide, diketopyrrolopyrrole, dibromanthranthrone, and zinc oxide.

6. The polymer emulsion composition according to any one of claims 1 through 5, wherein the complementary colored pigment is present in the polymer emulsion compound in an amount less than or equal to about 5000 ppm.

7. The polymer emulsion composition according to any one of claims 1 through 6, wherein the insoluble cupric compound is present in the polymer emulsion composition in an amount from about 100 ppm to about 1800 ppm Cu.

8. The polymer emulsion composition o according to any one of claims 1 through 7, wherein the insoluble cupric compound comprises micronized insoluble cupric compound particles, and wherein 50% or more of the micronized insoluble cupric compound particles have a median particle size of less than about 1 micron.

9. The polymer emulsion composition according to any one of claims 1 through 8, further comprising a co-biocide.

10. The polymer emulsion composition of claim 9, wherein the co-biocide comprises one or more derivative of quaternary ammonium, isothiazolinone, pyrithione, triazine, haloalkylnyl, hydantoin, and urea.

11. The polymer emulsion composition of claim 9, wherein the co-biocide comprises one or more of dimethyl benzyl ammonium chloride, N,N-didecyl-N,N-dimethyl ammonium chloride, N,N-didecyl-N,N-dimethyl ammonium carbonate/bicarbonate, zinc pyrithione, and sodium pyrithione.

12. The polymer emulsion composition of claim 9, wherein the co-biocide is present in the polymer emulsion compound in an amount of from about 50 ppm Cu to about 5500 ppm Cu.

13. The polymer emulsion composition according to any one of claims 1 through 12, further comprising an adjuvant.

14. The polymer emulsion composition of claim 13, wherein the adjuvant comprises one or more of 2-dicyandiamide and zinc trifluoroethylacetoacetate.

15. A latex paint composition comprising the polymer emulsion composition of claim 1.

16. An antimicrobial composition comprising:
an insoluble cupric compound; and
a complementary colored pigment,
wherein the insoluble cupric compound is present in the polymer composition in an amount less than about 4000 ppm Cu.
